(19) United States
(12) Patent Application Publication
(10) Pub. No.: US 2009/0303393 A1
(43) Pub. Date: Dec. 10, 2009

(54) SCART INTERFACE CONTROL CIRCUIT AND ELECTRONIC DEVICE USING THE SAME

(75) Inventor: YANG-BIN DIAO, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (SHENZHEN) CO., LTD., Shenzhen City (CN); HON HAI PRECISION INDUSTRY CO., LTD., Tu-cheng (TW)

(21) Appl. No.: 12/411,409

(22) Filed: Mar. 26, 2009

(30) Foreign Application Priority Data
Jun. 10, 2008 (CN) 200810302085.3

(51) Int. Cl. H04N 5/268

(52) U.S. Cl. 348/706; 348/E05.057

(57) ABSTRACT

An electronic device controlling video output of a SCART interface includes a video processing chip outputting at least two voltage signals, a SCART interface control circuit outputting different control voltage signals according to the at least two voltage signals, and a SCART interface converting formats of video output according to the different control voltage signals. The SCART interface control circuit includes a first switch circuit, a second switch circuit, and a voltage division circuit. The first and second switch circuits are respectively turned on or off by one of the at least two voltage signals. The voltage division circuit divides an external power to output the different control voltage signals based on the on or off states of the first switch circuit and the second switch circuit.

### BACKGROUND

1. Technical Field

The disclosure relates to network communications, and particularly to an electronic device with a SCART interface.

2. Description of Related Art

Communication terminals with video output consistent with European standard, such as TVs and set top boxes, are configured with SCART (Syndicat des Constructeurs d'Appareils Radiorécepteurs et Téléviseurs, Radio and Television Receiver Manufacturer's Association) interfaces. Video output from SCART interfaces can be converted according to input voltages based on definitions of SCART interfaces. For example, when an input of a SCART interface is 0 to 2V, video output of the SCART interface is a TV mode without signal output; when the input of the SCART interface is 4.5 to 7V, video output of the SCART interface is in the 16:9 mode; and when the input of the SCART interface is 9.5 to 12V, video output of the SCART interface is in the 4:3 mode.

Communication terminals with video output often have at least two SCART interfaces both connected to integrated circuits, with one being an input interface and the other being an output interface. For example, as shown in FIG. 1, an electronic device 1 includes a first SCART interface 10A and a second SCART interface 10B, both connected to an integrated circuit 20. The integrated circuit 20 is connected to a video processing chip 30 for controlling the first SCART interface 10A and the second SCART interface 10B according to output of the video processing chip 30. If the first SCART interface 10A is an input interface, and the second SCART interface 10B is an output interface, the integrated circuit 20 receives video from the first SCART interface 10A according to control of the video processing chip 30, and transmits control commands to the second SCART interface 10B to convert formats of video output.

However, the electronic device 1 needs at least two SCART interfaces and an integrated circuit, which increases manufacturing costs of the electronic device 1.

### BRIEF DESCRIPTION OF THE DRAWINGS

FIG. 1 is a schematic diagram of a commonly used electronic device with a plurality of SCART interfaces.

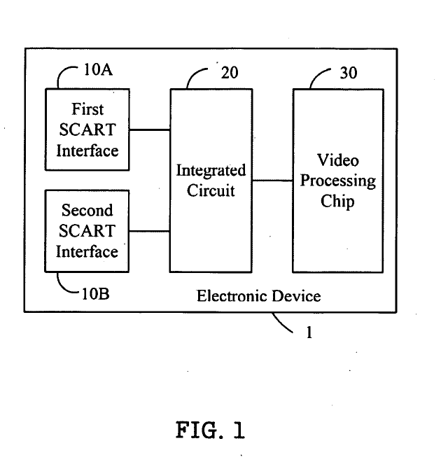

FIG. 2 is a schematic diagram of one embodiment of an electronic device as disclosed with only one SCART interface.

FIG. 3 is a circuit diagram of one embodiment of the SCART interface control circuit as disclosed, employed in an electronic device.

### DETAILED DESCRIPTION

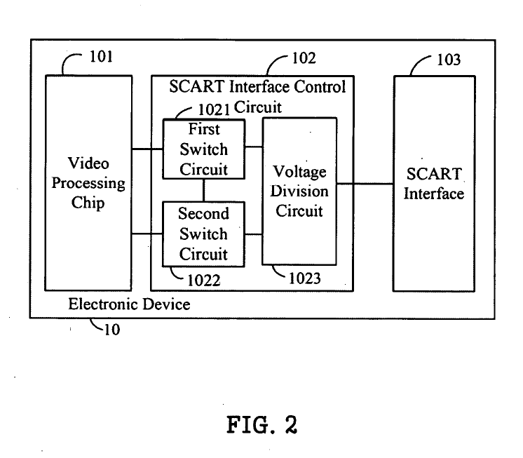

FIG. 2 is a schematic diagram of one embodiment of an electronic device 10 and a SCART interface control circuit 102 therein, as disclosed. In one embodiment, the electronic device 10 includes a video processing chip 101, the SCART interface control circuit 102 and a SCART interface 103. The video processing chip 101 may be a central processing unit of the electronic device 10 outputting at least two voltage signals to the SCART interface control circuit 102 through a universal serial bus. The SCART interface 103 receives and outputs video signals.

The SCART interface control circuit 102 receives the at least two voltage signals from the video processing chip 101, and outputs different control voltage signals according to the at least two voltage signals to control video output of the SCART interface 103. The SCART interface control circuit 102 includes a first switch circuit 1021, a second switch circuit 1022, and a voltage division circuit 1023.

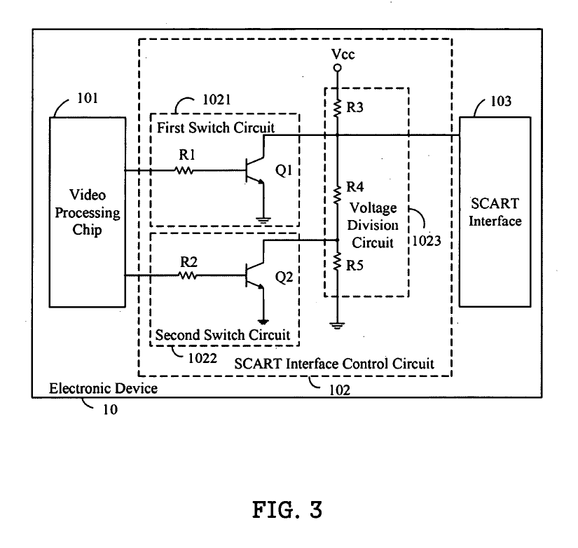

In one embodiment, the first switch circuit 1021 is turned on or off by one of the at least two voltage signals. The second switch circuit 1022 is turned on or off by another of the at least two voltage signals. The voltage division circuit 1023, connected to the first switch circuit 1021 and the second switch circuit 1022, is structured and arranged to divide an external power source Vcc (shown in FIG. 3) to output the different control voltage signals based on the on or off states of the first switch circuit 1021 and the second switch circuit 1022.

The SCART interface 103 is connected to the SCART interface control circuit 102, and converts formats of video output according to the different control voltage signals received from the SCART interface control circuit 102. In one example, the SCART interface 103 outputs no signals when the control voltage signal is 0 to 2V, video signals in the 16:9 format when the control voltage signal is 4.5 to 7V, and video signals of in the 4:3 format when the control voltage signal is 9.5 to 12V. However, it may be understood that these voltages may vary depending on the embodiment.

FIG. 3 is a circuit diagram of one embodiment of FIG. 2. In one embodiment, the first switch circuit 1021 includes a first resistor R1 and a first transistor Q1. The first resistor R1 has one end connected to the video processing chip 101 and another connected to a base of the first transistor Q1. The first transistor Q1 has a grounded emitter and a collector of an output of the SCART interface control circuit 102. The second switch circuit 1022 includes a second resistor R2 and a second transistor Q2. The second resistor R2 has one end connected to the video processing chip 101 and another connected to a base of the second transistor Q2. The second transistor Q2 has a grounded emitter and a collector connected to the voltage division circuit 1023. The voltage division circuit 1023 includes a third resistor R3, a fourth resistor R4, and a fifth resistor R5 connected in series. The third resistor R3 is connected between the external power source Vcc and the collector of the first transistor Q1. The fourth resistor R4 is connected between the collectors of the first transistor Q1 and the second transistor Q2. The fifth resistor R5 is connected between the collector of the second transistor Q2 and the ground.

The at least two voltage signals output by the video processing chip 101 to the first switch circuit 1021 and the second switch circuit 1022 respectively, may be high voltage signals or low voltage signals. In one embodiment, the high voltage signal is defined as 3.3V, and the low voltage signal 0V. The first resistor R1, the second resistor R2, and the fifth resistor R5 have a resistance of about 10K ohm, and the third resistor R3 and the fourth resistor R4 have a resistance of about 1K ohm, in one example. The first transistor Q1 and the second transistor Q2 may exhibit similar characteristics, and the external power source Vcc is about 12V, in one example.

When the video processing chip 101 outputs the high voltage signals to both the first switch circuit 1021 and the second switch circuit 1022, the first transistor Q1 and the second transistor Q2 turn on. At this time, the external power source Vcc, the third resistor R3, and the first transistor Q1 are connected in series, and the collector of the first transistor Q1 outputs a 0V signal. That is, the SCART interface control circuit 102 outputs a 0V signal.

When the video processing chip 101 outputs the high voltage signal to the first switch circuit 1021 and the low voltage signal to the second switch circuit 1022, the first switch circuit 1021 turns on and the second switch circuit 1022 turns off. In other words, the first transistor Q1 turns on and the second transistor Q2 turns off. At this time, the external power source Vcc, the third resistor R3, and the first transistor Q1 are still connected in series, and the collector of the first transistor Q1 outputs a 0V signal.

When the video processing chip 101 outputs the low voltage signal to the first switch circuit 1021 and the high voltage signal to the second switch circuit 1022, the first transistor Q1 of the first switch circuit 1021 turns off, and the second transistor Q2 of the second switch circuit 1022 turns on. At this time, the external power source Vcc, the third resistor R3, the fourth resistor R4, and the second transistor Q2 are connected in series, and the collector of the first transistor Q1 outputs a 6V signal.

When the video processing chip 101 outputs the low voltage signal to both the first switch circuit 1021 and the second switch circuit 1022, both the first transistor Q1 of the first switch circuit 1021 and the second transistor Q2 of the second switch circuit 1022 turn off. At this time, the external power source Vcc, the third resistor R3, the fourth resistor R4, and the fifth resistor R5 are connected in series, thus, the collector of the first transistor Q1 outputs a 11V signal.

The SCART interface 103 and the video processing chip 101 of the electronic device 10 are connected through switch circuits, which can turn on and off according to voltage signals output by the video processing chip 101 to divide the external power source Vcc to output control voltage signals, thus, the SCART interface 103 can convert formats of video output according to the control voltage signals. Thus, the SCART interface control circuit 102 can be effectively used in electronic devices with only one SCART interface to output video output of different formats, reducing the amount of integrated circuits required, thereby reducing manufacturing costs.

The foregoing disclosure of various embodiments has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto and their equivalents.

What is claimed is:

1. A Syndicat des Constructeurs d'Appareils Radiorécepteurs et Téléviseurs, Radio and Television Receiver Manufacturer's Association (SCART) interface control circuit, connected between a video processing chip and a SCART interface, for controlling video output of the SCART interface according to at least two voltage signals output by the video processing chip, the SCART interface control circuit comprising:
a first switch circuit turned on or off by one of the at least two voltage signals output by the video processing chip;
a second switch circuit turned on or off by another of the at least two voltage signals output by the video processing chip; and
a voltage division circuit structured and arranged for dividing an external power source to output different control voltage signals based on the on or off states of the first switch circuit and the second switch circuit.

2. The SCART interface control circuit of claim 1, wherein the first switch circuit comprises:
a first resistor with one end connected to the video processing chip; and
a first transistor with a base connected to another end of the first resistor, a grounded emitter, and a collector connected to the voltage division circuit.

3. The SCART interface control circuit of claim 2, wherein the second switch circuit comprises:
a second resistor with one end connected to the video processing chip; and
a second transistor with a base connected to another end of the second resistor, a grounded emitter, and a collector connected to the voltage division circuit.

4. The SCART interface control circuit of claim 3, wherein the voltage division circuit comprises:
a third resistor connected between the external power source and the collector of the first transistor;
a fourth resistor connected between the collectors of the first transistor and the second transistor; and
a fifth resistor connected between the collector of the second transistor and the ground;
wherein the collector of the first transistor is an output of the SCART interface control circuit to output the control voltage signals.

5. An electronic device, configured for controlling video output of a SCART interface, comprising:
a video processing chip configured for outputting at least two voltage signals;
a SCART interface control circuit configured for outputting different control voltage signals according to the at least two voltage signals, comprising:
a first switch circuit turned on or off by one of the at least two voltage signals;
a second switch circuit turned on or off by another of the at least two voltage signals; and
a voltage division circuit structured and arranged for dividing an external power source to output the different control voltage signals based on the on or off states of the first switch circuit and the second switch circuit; and
a SCART interface configured for converting formats of video output according to the different control voltage signals.

6. The electronic device of claim 5, wherein the video processing chip is a central processing unit of the electronic device outputting the at least two signals to the SCART interface control circuit through a universal serial bus.

7. The electronic device of claim 5, wherein the first switch circuit comprises:
a first resistor with one end connected to the video processing chip; and
a first transistor with a base connected to another end of the first resistor, a grounded emitter, and a collector connected to the voltage division circuit.

8. The electronic device of claim 7, wherein the second switch circuit comprises:
a second resistor with one end connected to the video processing chip; and
a second transistor with a base connected to another end of the second resistor, a grounded emitter, and a collector connected to the voltage division circuit.

9. The electronic device of claim 8, wherein the voltage division circuit comprises:
a third resistor connected between the external power source and the collector of the first transistor;
a fourth resistor connected between the collectors of the first transistor and the second transistor; and
a fifth resistor connected between the collector of the second transistor and the ground;
wherein the collector of the first transistor is an output of the SCART interface control circuit to output the control voltage signals.
